(19) United States
(12) Patent Application Publication
(10) Pub. No.: US 2026/0109914 A1
(43) Pub. Date: Apr. 23, 2026

(54) COMPOSITIONS AND METHODS FOR WASHING SURFACES IN THE MANUFACTURING INDUSTRY

(71) Applicant: ECOLAB USA Inc., St. Paul, MN (US)

(72) Inventors: Petia Todorova TONTCHEVA, Naperville, IL (US); Karen Gail PETERSON, Rosemount, MN (US); Jerald Alan DeFORD, Lenoir City, TN (US); Michael Richard NEY, Minneapolis, MN (US)

(73) Assignee: ECOLAB USA Inc., St. Paul, MN (US)

(21) Appl. No.: 19/359,559

(22) Filed: Oct. 15, 2025

Related U.S. Application Data
(60) Provisional application No. 63/709,261, filed on Oct. 18, 2024.

(51) Int. Cl. C11D 1/835; B01D 61/02; C11D 3/00; C11D 3/395; C11D 3/50

(52) U.S. Cl. CPC C11D 1/835; B01D 61/025; C11D 3/0026; C11D 3/395; C11D 3/50; C11D 2111/16; C11D 2111/18; C11D 2111/44

(57) ABSTRACT

The present disclosure provides compositions and methods for removing a contaminant from a surface. The methods include passing a fluid through a reverse osmosis (RO) membrane to form a RO fluid, adding a detergent to the RO fluid to form a treated fluid, applying the treated fluid to the surface, and removing at least a portion of the contaminant from the surface to form a treated surface. The methods also include the steps of adding a rinse aid to deionized water to form a second treated fluid and applying the second treated fluid to the treated surface.

### TECHNICAL FIELD

The present disclosure generally relates to compositions and methods for cleaning surfaces. More particularly, the disclosure pertains to compositions including detergents and/or rinse aids and methods of using the compositions for removing contaminants, such as lubricants (e.g., an oil), from a surface.

### BACKGROUND

In the production of food cans, lubricants are applied to a surface of the can during the body forming process. The lubricants need to be washed and rinsed from the can surface. Typically, the cans move on a conveyor-type washing system and are sprayed with different cleaning or rinse solutions to remove the lubricants applied during formation of the cup shape of the can.

The cans may be pre-washed with water from a dragout tank followed by heated water from a pre-wash tank. Then, the cans may be sprayed with detergent solution from a wash tank to remove the lubricants. The cans may be further sprayed with pre-treated soft water from a rinse tank followed by a rinse from a deionized water (DI) rinse tank. After use, the water from the DI rinse tank flows to a DI water system, which may be used for a final rinse of the cans.

### BRIEF SUMMARY

The present disclosure provides methods and compositions for removing a contaminant from a surface. A method of removing a contaminant from a surface may comprise passing a fluid through a reverse osmosis (RO) membrane to form a RO fluid, adding a detergent to the RO fluid to form a treated fluid, applying the treated fluid to the surface, removing at least a portion of the contaminant from the surface to form a treated surface, adding a rinse aid to deionized water to form a second treated fluid, and applying the second treated fluid to the treated surface.

A method of removing a lubricant from a surface of a can is also provided in the present disclosure. The method comprises passing a fluid through a reverse osmosis (RO) membrane to form a RO fluid, adding a detergent to the RO fluid to form a treated fluid, spraying the treated fluid onto the surface of the can, removing at least a portion of the lubricant from the surface to form a treated surface, adding a rinse aid to deionized water to form a second treated fluid, and spraying the second treated fluid onto the treated surface.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIG. 1 shows an example of a portion of a food can manufacturing process.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, organic, inorganic, and/or functionally modified. A polymer of the present disclosure can be in the form of a solution, a dry powder, a liquid, or a dispersion, for example.

The present disclosure provides compositions and methods for cleaning surfaces. In accordance with the present disclosure, “cleaning” contemplates removing at least a portion of a contaminant from a surface. In some instances, “cleaning” refers to removing the entire contaminant from a surface. A contaminant includes, for example, a lubricant, such as an oil (natural and/or synthetic), triethanolamine, 2-butylaminoethanol, tris(2-hydroxyethyl)hexahydro triazine, diethylene glycol, an alkyl ethanolamine, and any combination thereof.

A composition of the present disclosure may comprise a detergent. The composition may be formed by, for example, adding the detergent to a tank, such as a pre-wash spray tank, wash spray tank, dragout tank, rinse spray tank, and/or to any conduit in fluid communication with one or more of the foregoing tanks.

The detergent may be in solid form and/or in liquid form. The detergent may comprise a silicate. In some embodiments, the detergent may be caustic-based (e.g., including NaOH and/or KOH) or the detergent may be carbonate (ash)-based. In some embodiments, the detergent composition may comprise the components listed in Table 1.

TABLE 1
Caustic-based Detergent

| Component | Wt-% |
|---|---|
| Alkali metal hydroxide | 5-90 |
| Detersive Polymers and/or Surfactants | 1-20 |
| Water conditioning agents | 0-10 |
| Chelants | 0-20 |
| Hydrotropes | 0-10 |
| Additional functional ingredients | 0-60 |
| (additional alkalinity sources, defoamer, | |
| dispersant, metal protectant, processing | |
| aids, enzyme, fragrance, water and/or | |
| solidification aids, etc.) | |
| Total | 100 |

In some embodiments, the detergent composition may comprise from about 5 wt. % to about 80 wt. % of the alkali metal hydroxide, such as about 5 wt. % to about 70 wt. %, about 5 wt. % to about 60 wt. %, about 5 wt. % to about 50 wt. %, about 5 wt. % to about 40 wt. %, about 5 wt. % to about 30 wt. %, about 5 wt. % to about 20 wt. %, about 5 wt. % to about 10 wt. %, about 20 wt. % to about 80 wt. %, about 30 wt. % to about 80 wt. %, about 40 wt. % to about 80 wt. %, about 50 wt. % to about 80 wt. %, about 60 wt. % to about 80 wt. %, or about 70 wt. % to about 80 wt. %.

In some embodiments, the detergent composition may comprise the components listed in Table 2.

TABLE 2
Ash/Carbonate-based Detergent

| Component | Wt-% |
|---|---|
| Alkali metal carbonate | 1-80 |
| Detersive Polymers and/or Surfactants | 1-20 |
| Water conditioning agents | 0-10 |
| Chelants | 0-20 |
| Hydrotropes | 0-10 |
| Additional functional ingredients | 0-60 |
| (additional alkalinity sources, defoamer, | |
| dispersant, metal protectant, processing | |
| aids, enzyme, fragrance, water and/or | |
| solidification aids, etc.) | |
| Total | 100 |

In some embodiments, the detergent composition may comprise from about 5 wt. % to about 80 wt. % of the alkali metal carbonate, such as about 5 wt. % to about 70 wt. %, about 5 wt. % to about 60 wt. %, about 5 wt. % to about 50 wt. %, about 5 wt. % to about 40 wt. %, about 5 wt. % to about 30 wt. %, about 5 wt. % to about 20 wt. %, about 5 wt. % to about 10 wt. %, about 20 wt. % to about 80 wt. %, about 30 wt. % to about 80 wt. %, about 40 wt. % to about 80 wt. %, about 50 wt. % to about 80 wt. %, about 60 wt. % to about 80 wt. %, or about 70 wt. % to about 80 wt. %.

A detergent composition of the present disclosure may comprise, for example, a first surfactant comprising a first reverse ethylene oxide/propylene oxide (EO/PO) block copolymer, optionally a reverse EO/PO block copolymer of about 10-40 wt. % EO, optionally a reverse EO/PO block copolymer of about 20 wt. % EO, and a second surfactant comprising a second reverse EO/PO block copolymer of about 40 wt. % EO, an alkyl capped alcohol ethoxylate and/or alkyl pyrrolidone. Examples of the amounts of each component may be found in Table 3.

TABLE 3

| | Example 1 | Example 2 | Example 3 |
|---|---|---|---|
| Material | wt.-% Range | wt.-% Range | wt.-% Range |
| Reverse EO/PO block | 0.1-50 | 0.5-20 | 0.5-2 |
| copolymer | | | |
| Alkyl capped alcohol | 0.1-50 | 1-20 | 1-10 |
| ethoxylate | | | |
| Additional Functional | 0-90 | 0-75 | 0-50 |
| Ingredients and water | | | |
| earner | | | |
| Total | 100 | 100 | 100 |

A solid detergent composition of the present disclosure may comprise, for example, an alkalinity source (e.g., hydroxide, carbonate, reagents of alkali metal hydroxide and an organic molecule having at least one hydroxyl group (e.g., polyol) or alkylene carbonate, or combinations thereof) in combination with a surfactant composition including a first surfactant comprising a first reverse EO/PO block copolymer, optionally a reverse EO/PO block copolymer of about 10-40 wt. % EO, optionally a reverse EO/PO block copolymer of about 20 wt. % EO, for protein soil defoaming, and a second surfactant comprising at least one of a second reverse EO/PO block copolymer of about 40 wt. % EO, an alkyl capped alcohol ethoxylate, a capped block copolymer, and alkyl pyrrolidone for protein soil removal. In embodiments the solid compositions can further comprise at least one additional functional ingredient, such as a water conditioning agent, e.g., water conditioning polymer, hydrotrope and/or chelant. Examples of levels of components in the compositions can be seen in Table 4.

TABLE 4

| | Example 4 | Example 5 | Example 6 |
|---|---|---|---|
| Material | Range wt.-% | Range wt.-% | Range wt.-% |
| First Surfactant | 0.1-5 | 0.5-5 | 0.5-2 |
| Second Surfactant(s) | 0.1-20 | 1-20 | 1-10 |
| Alkalinity source | 10-90 | 25-90 | 30-80 |
| Additional Functional | 0-50 | 0-30 | 0-25 |
| Ingredients | | | |
| Total | 100 | 100 | 100 |

A detergent composition of the present disclosure may comprise a combination of a cationic/nonionic surfactant blend and a defoaming surfactant, in a ratio that provides a desirable low foam profile with contaminant removal. The composition may comprise an alkalinity source and a surfactant, such as a quaternary alkylamine alkoxylate. The alkalinity source may be selected from, for example, an alkali metal hydroxide, an alkali metal carbonate, an alkali metal silicate, an alkali metal metasilicate, an alkali metal bicarbonate, an alkali metal sesquicarbonate, and any combination thereof.

In some aspects, the defoaming surfactant and quaternary alkylamine alkoxylate are present in a ratio of less than 10:1, optionally from about 1:1 to about 5:1, such as about 2:1, about 3:1, or about 4:1.

Additional examples of detergents include disodium metasilicate, trisodium phosphate, potassium hydroxide, potassium silicate, sodium hydroxide, triphosphono methyl amine, sodium silicate, and any combination thereof.

In some embodiments, a detergent composition of the present disclosure includes one or both of disodium metasilicate and trisodium phosphate.

In some embodiments, a detergent composition of the present disclosure includes one or both of potassium hydroxide and potassium silicate.

In some embodiments, a detergent composition of the present disclosure includes one or more of sodium hydroxide, triphosphono methyl amine, and sodium silicate.

A composition may comprise any amount of the detergent active ingredient (e.g., sodium hydroxide, sodium silicate, trisodium phosphate, etc.). For example, a composition may comprise from about 0.1 wt. % to about 99 wt. % of the detergent, such as from about 0.1 wt. % to about 90 wt. about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 0.1 wt. % to about 5 wt. %, about 1 wt. % to about 90 wt. %, about 1 wt. % to about 75 wt. %, about 1 wt. % to about 50 wt. %, about 1 wt. % to about 25 wt. %, about 1 wt. % to about 15 wt. %, about 1 wt. % to about 10 wt. %, about 1 wt. % to about 5 wt. %, about 5 wt. % to about 75 wt. %, about 15 wt. % to about 60 wt. %, or about 25 wt. % to about 50 wt. %.

In some embodiments, a solid detergent composition of the present disclosure comprises a branched fatty acid disintegrator. A branched fatty acid disintegrator is defined herein as an additive to a solid detergent product which improves the dissolution rate of the solid product. In addition, the branched fatty acid disintegrator can enhance the cleaning ability of the solid product by lowering the surface tension of the aqueous use solution to allow better penetration of the use solution into the contaminant and act as a hydrotrope to stabilize the solid detergent composition and the use solution.

Branched fatty acid disintegrators useful in the present invention include C₅ to C₂₀ branched fatty acids and salts thereof. Representative branched structures can be described as iso-, neo-, sec- or tert-. In some embodiments, the branched fatty acid disintegrators are saturated C₅ to C₁₈ fatty acids which include one or more alkyl branches off the main alkyl chain. In certain embodiments, the branched fatty acid disintegrators are saturated C₅ to C₁₈ fatty acids which include one or two methyl branches off the main alkyl chain. In certain embodiments, the branched fatty acid disintegrators are represented by the formula CH₃(CH₂)ₘ(C R₁, R₂, R₃)ₙ(CH₂)ₒ(C R₁, R₂, R₃)ₚ(CH₂)_{q} COOH wherein m, n, o, p and q are each an integer selected from 0-17, and n+p is 1 or 2, and m+n+0+p+q is between 3 and 18 where R₁, R₂, R₃ can be independently a hydrogen or alkyl group with at least one being an alkyl group and the alkyl group is optionally a methyl group.

In some embodiments, the branched fatty acid disintegrators are salts of branched fatty acids. In certain embodiments, CH₃(CH₂)ₘ(C R₁, R₂, R₃)ₙ(CH₂)ₒ(C R₁, R₂, R₃)ₚ(CH₂)_{q} COOH wherein m, n, o, p and q are each an integer selected from 0-17, and n+p is 1 or 2, and m+n+0+p+q is between 6 and 18 where R₁, R₂, R₃ can be independently a hydrogen or alkyl group with at least one being an alkyl group and the alkyl group is preferably a methyl group.

Examples of suitable branched fatty acid disintegrators are sodium isononanoate, isononanoic acid, sodium isooctanoate, isooctanoic acid, sodium neodecanote, neodecanoic acid, sodium neopentanoate, neopentanoic acid, sodium neoheptanote, neoheptanoic acid, any of the acids shown below and salts thereof, or mixtures thereof.

Any solid detergent composition disclosed herein may include at least about 0.2 wt. % of a branched fatty acid disintegrator. In certain embodiments, the solid detergent composition includes between about 0.2 wt. % to about 5 wt. % of branched fatty acid disintegrator. In other embodiments, the solid detergent composition includes between about 0.2 wt. % to about 20 wt. % of the branched fatty acid disintegrator. Greater amounts of branched fatty acid disintegrator, such as greater than about 5 wt. %, are useful in solid detergent compositions where the branched fatty acid disintegrator also functions as a hydrotrope, surfactant and/or detersive component.

In some embodiments, a solid detergent composition of the present disclosure comprises a solidification agent, which may bind the detergent composition together to provide a solid detergent composition. A solid detergent composition may be prepared by providing a composition containing between about 10 wt. % and about 80 wt. % binding agent, or between about 1 wt. % and about 40 wt. % binding agent, and sufficient water to provide necessary hydration for solidification. In certain embodiments, the binding agent may also serve as an alkaline source.

The following U.S. patents disclose various combinations of solidification, binding and/or hardening agents and methods for solidification that may be utilized in the solid detergent compositions of the present disclosure. These U.S. patents are incorporated herein by reference in their entirety: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

In certain embodiments, a solid detergent composition includes about 10 wt. % to about 80 wt. % of sodium carbonate (Na₂CO₃), sodium hydroxide (NaOH), or sodium metasilicate, or combinations thereof, for solidification of the solid composition. The solid detergent composition may also include an effective amount of an organic phosphonate hardness sequestering agent comprising a potassium salt. In certain embodiments, a solid detergent composition includes about 10 wt. % to about 40 wt. % of sodium carbonate or about 20 wt. % to about 40 wt. %. In certain further embodiments, a solid detergent composition includes about 20 wt. % to about 40 wt. % sodium carbonate and about 15 wt. % to about 40 wt. % sodium hydroxide.

Additional examples of detergents that may be used in accordance with the present disclosure may be found in PCT/US24/20058, U.S. Pat. Nos. 10,577,565, 11,959,050, 7,442,679, 7,598,218, 7,759,300, 7,763,576, 8,138,138, 8,247,367, 8,389,464, and 8,759,268, the entire contents of which are expressly incorporated by reference into the present disclosure.

A composition of the present disclosure may comprise a rinse aid. The rinse aid reduces the formation of water droplets that leave behind spots or streaks on the surface. The composition may be formed by, for example, adding the rinse aid to a tank, such as a DI rinse spray tank and/or to any conduit leading to and in fluid communication with the DI rinse spray tank.

In some embodiments, a rinse aid composition of the present disclosure comprises the components and amounts listed in Table 5.

TABLE 5

| | SOLID | LIQUID |
|---|---|---|
| Component | Wt-% | Wt-% |
| Surfactant systems | 5-80 | 5-90 |
| Solidification Aids | 10-80 | — |
| Water and/or Solvents | 0-10 | 5-95 |
| Water conditioning agents | 0-10 | 0-10 |
| Chelants | 0-10 | 0-10 |
| Additional functional | 0-20 | 0-20 |
| ingredients (acidulent, | | |
| buffers, defoamer, | | |
| dispersant, metal protectant, | | |
| fragrance, etc.) | | |
| Total | 100 | 100 |

A rinse aid composition of the present disclosure may comprise at least one nonionic alcohol alkoxylate according to the following formulas (A or A2): R¹—O-(EO)ₓ₃(PO)_{y3}—H (A), wherein R¹ is a straight-chain C₁₀-C₁₆ alkyl, wherein x₃ is from 5 to 8, and wherein y₃ is from 2 to 5, or R¹—O-(EO)ₓ₄(PO)_{y4}—H (A2), wherein R¹ is a straight-chain C₁₀-C₁₆ alkyl, wherein x₄ is from 4 to 6, and wherein y₄ is from 3 to 5, and a nonionic alcohol alkoxylate according to the following formula: R²—O-(EO)ₓ₁—H (B), wherein R² is C₁₀-C₁₄ alkyl with an average of at least 2 branches per residue, and wherein x₁ is from 5 to 10. In certain aspects, the rinse aid composition may comprise a nonionic alcohol alkoxylate according to the following formula: R²—O-(EO)ₓ₂—H (C), wherein R² is C₁₀-C₁₄ alkyl with an average of at least 2 branches per residue, and wherein x₂ is from 2 to 4.

In still further embodiments, a rinse aid composition of the present disclosure may comprise at least one nonionic alcohol alkoxylate according to the following formulas (A or A2, B and D): R¹—O-(EO)ₓ₃(PO)_{y3}—H (A), wherein R¹ is a straight-chain C₁₀-C₁₆ alkyl, wherein x₃ is from 5 to 8, and wherein y₃ is from 2 to 5, or R¹—O-(EO)ₓ₄(PO)_{y4}—H (A2), wherein R¹ is a straight-chain C₁₀-C₁₆ alkyl, wherein x₄ is from 4 to 6, and wherein y₄ is from 3 to 5, and a nonionic alcohol alkoxylate according to the following formula: R²—O-(EO)ₓ₁—H (B), wherein R² is C₁₀-C₁₄ alkyl with an average of at least 2 branches per residue, and wherein x₁ is from 5 to 10; and a nonionic Guerbet alcohol alkoxylate according to the following formula: R⁷—O—(PO)_{y5}(EO)ₓ₅(PO)_{y6}—H (D), wherein R⁷ is a branched C₈-C₁₆ Guerbet alcohol, x₅ is from 5 to 30, y₅ is from 1 to 4, and y₆ is from 10 to 20.

The present disclosure also provides rinse aid compositions comprising a sheeting agent, a defoaming agent, an association disruption agent, and optionally an additional component, such as a carrier, a hydrotrope, a chelating/sequestering agent, and any combination thereof.

The sheeting agent may comprise a compound having the structure represented by formula I:

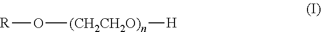

wherein R is a (C₁-C₁₂) alkyl group, and n is an integer in the range of 1 to 100. In some embodiments, n is an integer in the range of 10 to 50, 15 to 30, or 20-25, such as 21, 22, 23, or 24.

The defoaming agent may comprise a polymer compound including one or more ethylene oxide groups. In yet other embodiments, the defoaming agent includes a polyether compound prepared from ethylene oxide, propylene oxide, or a mixture thereof. In still yet other embodiments, the defoaming agent comprises a polyoxypropylene-polyoxyethylene block copolymer surfactant.

The association disruption agent may comprise an alcohol alkoxylate. In other embodiments, the association disruption agent is selected from the group consisting of ethylene oxides, propylene oxides, butylene oxides, pentalene oxides, hexylene oxides, heptalene oxides, octalene oxides, nonalene oxides, decylene oxides, and mixtures and derivatives thereof.

The sheeting agent may be present at about 1 wt. % to about 10 wt. %, such as about 2 wt. % to about 5 wt. %. The defoaming agent may be present at about 1 wt. % to about 10 wt. %, such as about 2 wt. % to about 5 wt. %. The association disruption agent may be present between about 1 wt. % to about 25 wt. %, such as about 10 wt. % to about 20 wt. %.

Additional examples of rinse aids include sodium xylene sulfonate, lactic acid, an ethoxylated alkyl alcohol, and any combination thereof.

In some embodiments, a rinse aid composition of the present disclosure comprises one or more of sodium xylene sulfonate, lactic acid, and an ethoxylated alkyl alcohol, such as a C₁₁ to C₁₄ ethoxylated alcohol.

Additional examples of rinse aids that may be used in accordance with the present disclosure may be found in U.S. Pat. Nos. 11,118,140, 12,122,984, 11,773,346, 11,479,742, US 2022/0154103, U.S. Pat. Nos. 9,543,184, 9,567,551, 10,221,376, 10,689,5979, and 10,745,650, the entire contents of which are expressly incorporated by reference into the present disclosure.

A composition may comprise any amount of the rinse aid. For example, a composition may comprise from about 0.1 wt. % to about 99 wt. % of the rinse aid, such as from about 0.1 wt. % to about 90 wt. about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 0.1 wt. % to about 5 wt. %, about 1 wt. % to about 90 wt. %, about 1 wt. % to about 75 wt. %, about 1 wt. % to about 50 wt. %, about 1 wt. % to about 25 wt. %, about 1 wt. % to about 15 wt. %, about 1 wt. % to about 10 wt. %, about 1 wt. % to about 5 wt. %, about 5 wt. % to about 75 wt. %, about 15 wt. % to about 60 wt. %, or about 25 wt. % to about 50 wt. %.

In some embodiments, a composition of the present disclosure may comprise a rinse aid and a detergent. For example, a rinse aid may be added to deionized water comprising a rinse aid. Also, deionized water comprising a rinse aid may be added to a RO fluid comprising a detergent.

The compositions of the present disclosure may include (or exclude) one or more additional components (other than the detergent and/or rinse aid) and/or one or more additional components may be added to the surface to be treated before, after, and/or with a composition of the present disclosure comprising the rinse aid and/or detergent.

Illustrative, non-limiting examples of additional components include a chelating agent, an alkaline source, a bleaching agent, a sanitizer/anti-microbial agent, an activators, a detergent builder or filler, a defoaming agent, an anti-redeposition agent, an optical brightener, a dye, an odorant, a secondary hardening agent/solubility modifier, or any combination thereof.

In some embodiments, the additional component may be selected from a carrier, a hydroptrope, a chelating agent, a bleach and/or bleach activator, a sanitizer and/or antimicrobial agent, an activator, a detergent builder or filler, an anti-redeposition agent, an optical brightener, a dye, an odorant or perfume, a preservative, a stabilizer, a processing aid, a corrosion inhibitor, a filler, a solidifier, a hardening agent, a solubility modifier, a pH adjusting agent, a humectant, a water treatment polymer and/or phosphonate, a functional polydimethylsiloxone, or any combination thereof.

In some embodiments, the compositions of the present disclosure are formulated as liquid compositions. Carriers can be included in such liquid formulations. Any carrier suitable for use in a rinse aid composition can be used. For example, in some embodiments, the compositions include water as a carrier or any other medium disclosed herein (e.g., RO fluid, deionized water, etc.).

In some embodiments, the compositions of the present disclosure can include a hydrotrope. The hydrotrope may be used to aid in maintaining the solubility of sheeting or wetting agents. Hydrotropes can also be used to modify the compositions creating increased solubility for the organic material. In some embodiments, hydrotropes are low molecular weight aromatic sulfonate materials, such as xylene sulfonates, dialkyldiphenyl oxide sulfonate materials, and cumene sulfonates.

A chelating agent may include, for example, an aminocarboxylic acid, a condensed phosphate, a phosphonate, a polyacrylate, and mixtures and derivatives thereof. In general, a chelating agent is a molecule capable of coordinating (i.e., binding) the metal ions commonly found in natural water to prevent the metal ions from interfering with the action of the other ingredients of a composition of the present disclosure.

A bleaching agent may be selected from, for example, a chlorine-containing compound, such as a hypochlorite and/or a chloramine, an alkali metal dichloroisocyanurates, a chlorinated trisodium phosphate, an alkali metal hypochlorites, monochloramine and dichloroamine, and any combination thereof.

An antimicrobial agent is a chemical composition that can be used in a functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, and organosulfur and sulfur-nitrogen compounds. Specific examples include phenolic antimicrobials, such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents, such as benzalkonium chloride, didecyldimethyl ammonium chloride, choline diiodochloride, tetramethyl phosphonium tribromide. Other antimicrobial compositions, such as hexahydro-1,3,5-tris(2-hydroxyethyl)-s-triazine, dithiocarbamates, such as sodium dimethyldithiocarbamate, and a variety of other materials are known in the art for their antimicrobial properties.

An activator is a material which, when the composition is placed in use, reacts with the active oxygen to form an activated component. For example, in some embodiments, a peracid or a peracid salt is formed. For example, in some embodiments, tetraacetylethylene diamine can be included within the composition to react with the active oxygen and form a peracid or a peracid salt that acts as an antimicrobial agent. Other examples of active oxygen activators include transition metals and their compounds, compounds that contain a carboxylic, nitrile, or ester moiety, or other such compounds known in the art. In an embodiment, the activator includes tetraacetylethylene diamine, a transition metal, a compound that includes carboxylic, nitrile, amine, or ester moiety, or any mixture thereof.

Examples of suitable fillers may include sodium sulfate, sodium chloride, starch, sugars, C₁-C₁₀ alkylene glycols such as propylene glycol, and the like.

Examples of anti-redeposition agents include fatty acid amides, fluorocarbon surfactants, complex phosphate esters, styrene maleic anhydride copolymers, and cellulosic derivatives, such as hydroxyethyl cellulose, hydroxypropyl cellulose, and the like.

Various dyes, odorants including perfumes, and other aesthetic enhancing agents may also be included in the composition. Dyes may be included to alter the appearance of the composition, as for example, FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that may be included in the compositions include, for example, terpenoids, such as citronellol, aldehydes, such as amyl cinnamaldehyde, a jasmine, such as C1S-jasmine or jasmal, vanillin, and the like.

A solid composition may include a hardening agent, such as an amide (e.g., stearic monoethanolamide or lauric diethanolamide), or an alkylamide, and the like; a solid polyethylene glycol, urea or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the rinse aid and/or other active ingredients may be dispensed from the solid composition over an extended period of time.

A functional polydimethylsiloxone includes, for example, a polyalkylene oxide-modified polydimethylsiloxane, nonionic surfactant or a polybetaine-modified polysiloxane amphoteric surfactant. Both, in some embodiments, are linear polysiloxane copolymers to which polyethers or polybetaines have been grafted through a hydrosilation reaction. Some examples of specific siloxane surfactants are known as SILWET® surfactants available from Union Carbide or ABIL® polyether or polybetaine polysiloxane copolymers available from Goldschmidt Chemical Corp., and described in U.S. Pat. No. 4,654,161 which patent is incorporated herein by reference. In some embodiments, the particular siloxanes used can be described as having, e.g., low surface tension, high wetting ability and excellent lubricity. For example, these surfactants are said to be among the few capable of wetting polytetrafluoroethylene surfaces. The siloxane surfactant employed as an additive can be used alone or in combination with a fluorochemical surfactant. In some embodiments, the fluorochemical surfactant employed as an additive optionally in combination with a silane, can be, for example, a nonionic fluorohydrocarbon, for example, fluorinated alkyl polyoxyethylene ethanols, fluorinated alkyl alkoxylate and fluorinated alkyl esters.

Examples of humectants include glycerin, propylene glycol, sorbitol, alkyl polyglycosides, polybetaine polysiloxanes, and mixtures thereof.

The additional component may be added to the surface (and/or treated surface) before, after, and/or with the detergent and/or rinse aid. If a composition of the present disclosure comprises the additional component, the composition may comprise from, for example, about 0.1 wt. % to about 50 wt. % (or more) of the component, such as from about 0.1 wt. % to about 25 wt. %, about 0.1 wt. % to about 20 wt. %, about 0.1 wt. % to about 15 wt. %, about 0.1 wt. % to about 10 wt. %, about 0.1 wt. % to about 5 wt. %, about 1 wt. % to about 5 wt. %, about 1 wt. % to about 10 wt. %, about 1 wt. % to about 15 wt. %, about 5 wt. % to about 15 wt. %, or about 5 wt. % to about 20 wt. %.

Any composition disclosed herein, such as a composition comprising a detergent, a composition comprising a rinse aid, and/or a composition comprising an additional component may further comprise a fluorescent tracer. The tracer may be an inert tracer, meaning it does not interact with and/or interfere with any of the detergents, rinse aids, and/or additional components present in the composition. The tracer may be independently present in the composition or it may be attached (e.g., bonded) to a component in the composition, such as a detergent, a rinse aid, and/or additional component.

The tracer is not particularly limited and may be any inert compound capable of emitting a fluorescent signal. Illustrative, non-limiting examples of tracers include disodium 1,5-naphthalene disulfonate, pyrenetetrasulfonic acid, fluorescein potassium salt, and any combination thereof.

It should be understood that any composition, fluid, RO fluid, treated fluid, or other medium disclosed herein may exclude, comprise, consist of, or consist essentially of any detergent, rinse aid, tracer, and/or additional component disclosed herein.

Further, the compositions of the present disclosure can be provided as a solid, powder, liquid, gel, or a combination thereof. In some embodiments, a composition may be provided as a concentrate such that the composition is substantially free of water. The concentrate can be formulated without any water or can be provided with a relatively small amount of water (e.g., 3 wt. % or less) in order to reduce the expense of transporting the concentrate. For example, the concentrate can be provided as a capsule or pellet of compressed powder, a solid, or loose powder, which may be contained by a water-soluble material. In use, the concentrate is diluted (such as with process water) into a use composition and applied to a surface.

The methods, compounds, and compositions disclosed herein may be used in any industrial systems, such as an aqueous industrial system. The compositions, compounds, and methods disclosed herein can be applied in any industry where it is desirable to remove a contaminant, such as a lubricant (e.g., an oil), from a surface.

In accordance with certain aspects of the present disclosure, a method of removing a contaminant from a surface is provided. The method comprises passing a fluid through a reverse osmosis (RO) membrane to form a RO fluid. The fluid is not particularly limited and may include, for example, fresh water, municipal water, recycled water, soft water, potable water, or any mixture thereof.

Any detergent (or combination of detergents) disclosed herein may be added to the RO fluid to form a treated fluid.

The amount of detergent added to the RO fluid is not particularly limited. For example, from about 1 ppm to about 5,000 ppm of the detergent may be added to the RO fluid, such as about 1 ppm to about 2,500 ppm, about 1 ppm to about 2,000 ppm, about 1 ppm to about 1,500 ppm, about 1 ppm to about 1,000 ppm, about 1 ppm to about 750 ppm, about 1 ppm to about 500 ppm, about 1 ppm to about 250 ppm, about 1 ppm to about 100 ppm, about 25 ppm to about 5,000 ppm, about 25 ppm to about 2,500 ppm, about 25 ppm to about 1,500 ppm, about 25 ppm to about 1,000 ppm, or about 25 ppm to about 500 ppm.

The treated fluid is then applied to the surface comprising the contaminant such that the detergent may interact with, dislodge, and remove the contaminant from the surface. The contaminant may be partially removed from the surface or fully removed from the surface to form a cleaned/treated surface.

The methods disclosed herein also include a step of adding any rinse aid (or combination of rinse aids) disclosed herein to deionized water to form a second treated fluid. The second treated fluid is then applied to the cleaned/treated surface. In some embodiments, a rinse aid or a rinse aid in deionized water may be added to the RO fluid comprising the detergent.

The amount of rinse aid added to the deionized water (or RO fluid) is not particularly limited. For example, from about 1 ppm to about 5,000 ppm of the rinse aid may be added to the deionized water, such as about 1 ppm to about 2,500 ppm, about 1 ppm to about 2,000 ppm, about 1 ppm to about 1,500 ppm, about 1 ppm to about 1,000 ppm, about 1 ppm to about 750 ppm, about 1 ppm to about 500 ppm, about 1 ppm to about 250 ppm, about 1 ppm to about 100 ppm, about 25 ppm to about 5,000 ppm, about 25 ppm to about 2,500 ppm, about 25 ppm to about 1,500 ppm, about 25 ppm to about 1,000 ppm, or about 25 ppm to about 500 ppm.

Methods disclosed herein optionally include a step of washing the surface with a heated fluid. This step may be carried out at any time during the process, such as before and/or after the treated fluid is applied to the surface, before and/or after the second treated fluid is applied to the surface, etc. The heated fluid may comprise, for example, fresh water, municipal water, recycled water, soft water, potable water, or any mixture thereof.

The heated fluid may be heated to temperatures from about 50° F. to about 200° F., prior to addition, such as from about 60° F. to about 200° F., about 75° F. to about 200° F., about 100° F. to about 200° F., about 125° F. to about 200° F., about 140° F. to about 200° F., about 140° F. to about 160° F., about 120° F. to about 140° F., or about 70° F. to about 80° F. It should be understood that any composition, fluid, RO fluid, treated fluid, or other medium disclosed herein may be heated to any of the foregoing temperatures.

In some embodiments, the compositions, compounds, and methods of the present disclosure may be used in automotive paint plant where the parts to be painted need to be cleaned and rinsed. In some embodiments, the compositions, compounds, and methods of the present disclosure may be used to remove a contaminant, such as a lubricant (e.g., an oil), from a surface of a can.

For example, in the production of food cans, such as tin coated steel food cans, the lubricants applied during the can body formation process need to be washed and rinsed away from the can body. The detergent compositions disclosed herein may be used for the washing portion of the process and the rinse aid compositions disclosed herein may be applied thereafter.

A can manufacturing process may utilize a flat metal sheet, which comprises a lubricant, that is transported to a cupper and bodymaker. At the cupper and bodymaker, additional lubricants are typically applied and the flat metal sheet is formed into the shape of a can. The can is then washed with detergent and rinsed with rinse aid. Subsequently, the cans are epoxy coated with one or more (such as two, three, etc.) water-soluble epoxy coatings and dried at high temperatures, such as about 70° F. to about 200° F.

In some embodiments, heat may be applied to the can (such as through a blower, furnace, etc.) after the second treated fluid (deionized water+rinse aid) is applied to the can, to completely dry the can before the first epoxy coating is applied to the outside of the can.

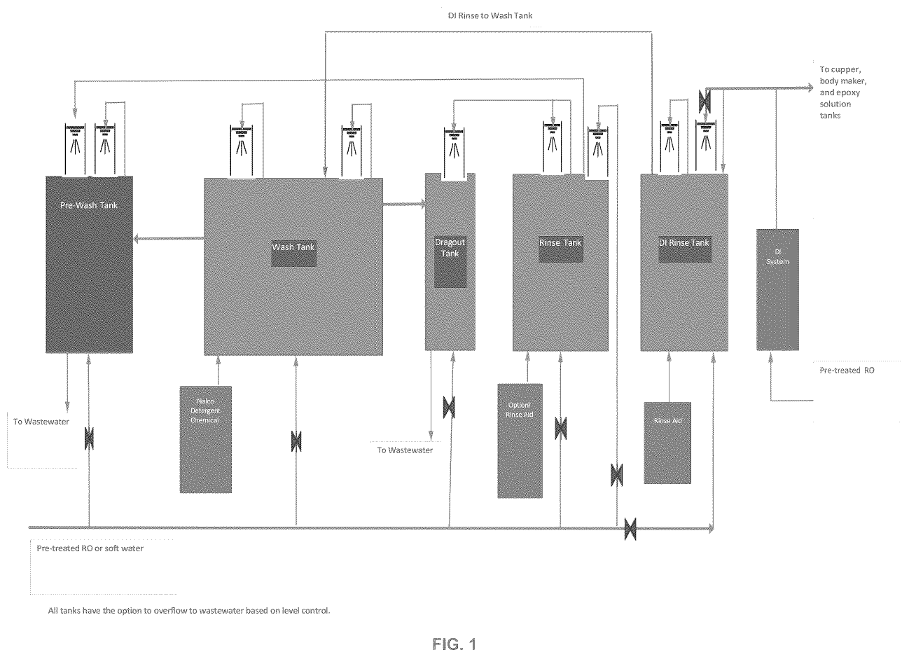

A portion of a food can manufacturing process can be seen in FIG. 1, wherein a heated RO fluid from a rinse tank is sprayed onto a surface of a can, such as a food or beverage can (not shown). The temperature of the heated fluid is not particularly limited and may be, for example, from about 60° F. to about 180° F., such as about 70° F. to about 140° F. Next, a heated RO fluid from the pre-wash spray tank is sprayed onto the surface. The temperature of this fluid is not particularly limited and may be from, for example, about 120° F. to about 180° F., such as about 140° F. to about 160° F. The can is then transported, such as by a conveyor belt, to an additional chemical sprayer, which applies the treated fluid (RO fluid+detergent) to the surface. The temperature of the treated fluid is not particularly limited and may be from, for example, about 120° F. to about 180° F., such as about 140° F. to about 160° F. Although two chemical sprayers are shown in FIG. 1, any number of sprayers may be used to apply the treated fluid (or any medium disclosed herein) to a surface. Optionally, deionized water+rinse aid may be added to the wash tank, which comprises RO fluid and detergent. The treated surface is transported to an additional chemical sprayer at the dragout tank, where it is sprayed with heated RO fluid from the rinse spray tank. The temperature of this fluid is not particularly limited and may be from, for example, about 60° F. to about 160° F., such as about 70° F. to about 140° F. Next, the surface is once again sprayed with heated RO fluid from the rinse spray tank and subsequently transported to a DI rinse spray tank, wherein it is sprayed with a heated second treated fluid (DI water+rinse aid). The temperature of the second treated fluid is not particularly limited and may be from, for example, about 60° F. to about 160° F., such as about 70° F. to about 140° F.

Any method disclosed herein may be carried out with an automated monitoring and controlling system, which may be used for measuring, controlling, and/or optimizing one or more system parameters or properties of a medium (e.g., fluid, RO fluid, DI water, treated fluid, second treated fluid, etc.) in the process. Optimization can include, for example, measuring one or more properties associated with the medium to be sure that the one or more properties are within an acceptable, predetermined range and, if the one or more properties are not within the acceptable, predetermined range for each respective property being measured, causing a change in the medium to bring the property back within the acceptable, predetermined range.

In certain embodiments, the system includes a monitoring and controlling unit that comprises a controller and a plurality of sensors. Each of the plurality of sensors can be in communication with the controller. For example, if the unit comprises five sensors, each of the five sensors can be in communication with the controller. In certain aspects, the monitoring and controlling unit can be attached to a skid, or other type of support member, to allow for mobility.

As used herein, the term “controller” refers to a manual operator or an electronic device having components, such as a processor, memory device, digital storage medium, a communication interface including communication circuitry operable to support communications across any number of communication protocols and/or networks, a user interface (e.g., a graphical user interface that may include cathode ray tube, liquid crystal display, plasma display, touch screen, or other monitor), and/or other components.

The controller is preferably operable for integration with one or more application-specific integrated circuits, programs, computer-executable instructions or algorithms, one or more hard-wired devices, wireless devices, and/or one or more mechanical devices. Moreover, the controller is operable to integrate the feedback, feed-forward, and/or predictive loop(s) of the invention. Some or all of the controller system functions may be at a central location, such as a network server, for communication over a local area network, wide area network, wireless network, internet connection, microwave link, infrared link, wired network (e.g., Ethernet) and the like. In addition, other components, such as a signal conditioner or system monitor, may be included to facilitate signal transmission and signal-processing algorithms.

In certain aspects, the controller includes hierarchy logic to prioritize any measured or predicted properties associated with system parameters. For example, the controller may be programmed to prioritize system pH over conductivity, or vice versa. It should be appreciated that the object of such hierarchy logic is to allow improved control over the system parameters and to avoid circular control loops.

In some embodiments, the monitoring and controlling unit and method associated therewith includes an automated controller. In some embodiments, the controller is manual or semi-manual. For example, when the system includes one or more datasets received from various sensors in the system, the controller may either automatically determine which data points/datasets to further process or an operator may partially or fully make such a determination. A dataset for an industrial body of water, for instance, may include variables or system parameters such as oxidation/reduction potential (ORP), dissolved oxygen (DO), conductivity, pH, turbidity, concentrations of certain chemicals, such as detergents, rinse aids, biocides, corrosion inhibitors, scale inhibitors, friction reducers, acids, bases, and/or oxygen scavengers, levels of ions (e.g., determined empirically, automatically, fluorescently, electrochemically, colorimetrically, measured directly, calculated), temperature, pressure, flow rate, total dissolved or suspended solids, etc. Such system parameters are typically measured with any type of suitable data capturing equipment, such as sensors designed specifically for these parameters, e.g., pH sensors, ion analyzers, temperature sensors, thermocouples, pressure sensors, corrosion probes, and/or any other suitable device or sensor. Data capturing equipment is in communication with the controller and, according to some embodiments, may have advanced functions (including any part of the control algorithms described herein) imparted by the controller.

The monitoring and controlling unit may comprise a plurality of sensors, which are capable of analyzing the medium and transmitting data regarding the medium to the controller. The plurality of sensors can comprise, for example, sensors for measuring conductivity, pH, ORP, biocide concentration, turbidity, temperature, flow, and DO in the medium. The monitoring and controlling unit may comprise any of these sensors, all of these sensors, a combination of two or more of these sensors, one or more additional sensors not specifically mentioned here, and the sensors may be in communication with the controller.

The monitoring and controlling unit may further comprise a fluorometer. The fluorometer is configured to measure a fluorescent signal of a fluorescent tracer in the medium. If the medium comprises two or more tracers that are different, the fluorometer is capable of measuring a fluorescent signal of each different tracer.

In an illustrative, non-limiting embodiment, a tracer may be added to the medium in a known amount with a detergent and/or rinse aid. A portion (such as a side stream) of the medium may be continuously routed through the monitoring and controlling unit and passed by any of the sensors disclosed herein and/or passed through a fluorometer. The fluorometer detects a fluorescent signal from the portion of the medium and transmits the signal to the controller, which analyzes the signal and determines an amount of tracer in the medium, which may be proportional to the amount of detergent and/or rinse aid in the medium. If the signal is below a predetermined value, the controller may carry out a corrective action, such as sending a signal to a chemical injection pump causing the pump to add additional detergent and/or rinse aid to the medium until the fluorescent signal is brought back within the predetermined acceptable range.

The presently disclosed monitoring and controlling system comprises, in certain embodiments, one or more chemical injection pumps. Each chemical injection pump may be in fluid communication with a storage device. Each storage device may comprise one or more chemicals and the chemical injection pumps may transport those chemicals into the body of water. In some embodiments, the chemical injection pump comprises the storage device. The chemical injection pumps may be in communication with the controller in any number of ways, such as through any combination of wired connection, a wireless connection, electronically, cellularly, through infrared, satellite, or according to any other types of communication networks, topologies, protocols, standards and more. Accordingly, the controller can send signals to the pumps to control their chemical (e.g., rinse aid, detergent, etc.) feed rates.

In certain embodiments, the monitoring and controlling system is implemented to have the plurality of sensors, fluorometer, etc., provide continuous or intermittent feedback, feed-forward, and/or predictive information to the controller, which can relay this information to a relay device, such as the Nalco Global Gateway, which can transmit the information via cellular communications to a remote device, such as a cellular telephone, computer, and/or any other device that can receive cellular communications. This remote device can interpret the information and automatically send a signal (e.g. electronic instructions) back, through the relay device, to the controller to cause the controller to make certain adjustments to the output of the pumps. The information can also be processed internally by the controller and the controller can automatically send signals to the pumps to adjust the amount of chemical injection, for example. Based upon the information received by the controller from the plurality of sensors, fluorometer, or from the remote device, the controller may transmit signals to the various pumps to make automatic, real-time adjustments, to the amount of chemical that the pumps are injecting into the medium.

Alternatively, an operator of the remote device that receives cellular communications from the controller can manually manipulate the pumps through the remote device. The operator may communicate instructions, through the remote device, cellularly or otherwise, to the controller and the controller can make adjustments to the rate of chemical addition of the chemical injection pumps. For example, the operator can receive a signal or alarm from the remote device through a cellular communication from the controller and send instructions or a signal back to the controller using the remote device to turn on one or more of the chemical injection pumps, turn off one or more of the chemical injection pumps, increase or decrease the amount of chemical being added to the medium by one or more of the injection pumps, or any combination of the foregoing. The controller and/or the remote device is also capable of making any of the foregoing adjustments or modifications automatically without the operator actually sending or inputting any instructions. Preset parameters or programs are entered into the controller or remote device so that the controller or remote device can determine if a measured property is outside of an acceptable range. Based on the information received by the plurality of sensors and/or fluorometer, the controller or remote device can make appropriate adjustments to the pumps or send out an appropriate alert.

In certain embodiments, the remote device or controller can include appropriate software to receive data from the plurality of sensors and/or fluorometer and determine if the data indicates that one or more measured properties of the medium are within, or outside, an acceptable range. The software can also allow the controller or remote device to determine appropriate actions that should be taken to remedy the property that is outside of the acceptable range. For example, if the measured pH is above the acceptable range, the software allows the controller or remote device to make this determination and take remedial action, such as alerting a pump to increase the flow of an acid into the medium.

The monitoring and controlling system and/or controller disclosed herein can incorporate programming logic to convert analyzer signals from the plurality of sensors and/or fluorometer to pump adjustment logic and, in certain embodiments, control one or more of a plurality of chemical injection pumps with a unique basis. Non-limiting, illustrative examples of the types of chemical injection pumps that can be manipulated include chemical injection pumps responsible for injecting rinse aids, detergents, biocides, scale inhibitors, friction reducers, acids, bases, sulfites, oxygen scavengers, and any other type of chemical that could prove to be useful in the particular medium. Specific examples of rinse aids, detergents, biocides, scale inhibitors, friction reducers, acids, bases, sulfites, and oxygen scavengers are all well-known in the art and all examples of such chemicals are within the scope of the present disclosure.

The fluorometer and sensors disclosed herein are operable to sense and/or predict a property associated with the medium or system parameter and convert the property into an input signal, e.g., an electric signal, capable of being transmitted to the controller. A transmitter associated with the fluorometer and each sensor transmits the input signal to the controller. The controller is operable to receive the transmitted input signal, convert the received input signal into an input numerical value, analyze the input numerical value to determine if the input numerical value is within an acceptable range, generate an output numerical value, convert the output numerical value into an output signal, e.g., an electrical signal, and transmit the output signal to a receiver, such as a pump incorporating such receiver capabilities or a remote device, such as a computer or cellular telephone, incorporating receiver capabilities. The receiver receives the output signal and either alerts an operator to make adjustments to flow rates of the pumps, or the receiver can be operable to cause a change in a flow rate of the pumps automatically, if the output numerical value is not within the acceptable range for that property.

The method is optionally repeated for a plurality of different system parameters, where each different system parameter has a unique associated property, or, alternatively, all system parameters can be analyzed concurrently by fluorometer and the plurality of sensors.

Data transmission of measured parameters or signals to chemical pumps, alarms, remote monitoring devices, such as computers or cellular telephones, or other system components is accomplished using any suitable device, and across any number of wired and/or wireless networks, including as examples, WiFi, WiMAX, Ethernet, cable, digital subscriber line, Bluetooth, cellular technologies (e.g., 2G, 3G, Universal Mobile Telecommunications System (UMTS), GSM, Long Term Evolution (LTE), or more) etc. The Nalco Global Gateway is an example of a suitable device. Any suitable interface standard(s), such as an Ethernet interface, wireless interface (e.g., IEEE 802.11a/b/g/x, 802.16, Bluetooth, optical, infrared, radiofrequency, etc.), universal serial bus, telephone network, the like, and combinations of such interfaces/connections may be used.

As used herein, the term “network” encompasses all of these data transmission methods. Any of the described devices (e.g., archiving systems, data analysis stations, data capturing devices, process devices, remote monitoring devices, fluorometers, sensors, chemical injection pumps, etc.) may be connected to one another using the above-described or other suitable interface or connection.

In some embodiments, system parameter information is received from the system and archived. In certain embodiments, system parameter information is processed according to a timetable or schedule. In some embodiments, system parameter information is immediately processed in real-time or substantially real-time. Such real-time reception may include, for example, “streaming data” over a computer network.

The chemicals to be added to the system, such as the rinse aids, detergents, acids, bases, biocides, scale inhibitors, corrosion inhibitors, friction reducers, etc., may be introduced to the medium using any suitable type of chemical injection pump. Most commonly, positive displacement injection pumps are used and are powered either electrically or pneumatically. Continuous flow injection pumps can also be used to ensure specialty chemicals are adequately and accurately injected into the medium. Though any suitable pump or delivery system may be used, exemplary pumps and pumping methods include those disclosed in U.S. Pat. No. 5,066,199, titled “Method for Injecting Treatment Chemicals Using a Constant Flow Positive Displacement Pumping Apparatus” and U.S. Pat. No. 5,195,879, titled “Improved Method for Injecting Treatment Chemicals Using a Constant Flow Positive Displacement Pumping Apparatus,” each incorporated herein by reference in its entirety.

In some embodiments, changes in the chemical injection pumps are limited in frequency. In some aspects, adjustment limits are set at a maximum of 1 per 15 min and sequential adjustments in the same direction may not exceed 8, for example. In some embodiments, after 8 total adjustments or a change of 50% or 100%, the pump could be suspended for an amount of time (e.g., 2 or 4 hours) and alarm could be triggered. If such a situation is encountered, it is advantageous to trigger an alarm to alert an operator. Other limits, such as maximum pump output, may also be implemented. It should be appreciated that it is within the scope of the invention to cause any number of adjustments in any direction without limitation. Such limits are applied as determined by the operator or as preset into the controller.

In accordance with certain embodiments of the present disclosure, a method of monitoring and controlling one or more properties of a medium, such as an aqueous medium, is provided. The properties can be, for example, pH, conductivity, turbidity, flow, detergent concentration, rinse aid concentration, biocide concentration, etc.

The method includes the use of a monitoring and controlling unit comprising a controller, a fluorometer, and a plurality of sensors in communication with the controller. Each of the plurality of sensors is operable to measure a property of the medium and the fluorometer is operable to measure a fluorescent signal being emitted from the medium. For example, in some embodiments, the unit comprises a fluorometer and three sensors, wherein each sensor is operable to measure a different property, such as pH, conductivity, and turbidity.

One or more pumps, which are in communication with the controller, are utilized to inject various chemicals into the water, such as rinse aids, detergents, corrosion inhibitors, biocides, and oxygen scavengers. Each chemical may have its own chemical injection pump.

An acceptable range for each of the one or more properties of the medium to be measured is entered into the controller. A conduit may be provided between the medium and the monitoring and controlling unit. A sample of medium passes through the conduit and into an inlet of the monitoring and controlling unit. Next, one or more properties of the medium are measured using a fluorometer and/or a plurality of sensors and the controller determines if the measured one or more properties are within the acceptable range entered into the controller in the previous step. This determining step can be automatically performed by the controller and in this step, the measured value for each measured property is compared to the acceptable range entered for that specific property.

If the measured one or more properties are outside of the acceptable range associated with that property, the controller and/or operator of the controller may cause a change, for example, in an influx of a chemical into the medium from the one or more chemical injection pumps, the chemical(s) being capable of adjusting the measured property and bringing it back within the acceptable range. The controller is operable to determine when the measured property is back within the acceptable range and subsequently turn off the chemical injection pump(s).

In an illustrative embodiment, if the fluorescent signal drops below a predetermined value, additional rinse aid could be added to the medium.

In an illustrative embodiment, if the pH of the medium drops below a predetermined value, additional detergent may be added to the medium. For example, a target pH value for a particular medium may range from about 9 to about 10. If the pH of the medium drops below 9, additional detergent may be added.

In certain instances, if the conductivity drops below a predetermined value, additional detergent may be added to the medium. For example, a target conductivity value for a particular medium may range from about 1,000 to about 2,000 μS/cm. If the conductivity of the medium drops below 1,000 μS/cm, additional detergent may be added.

The compositions, components, and/or compounds disclosed herein may be added to a surface using a variety of different application methods known in the art. In some embodiments, the compositions, components, and/or compounds may be added automatically and/or manually. The addition may involve dripping, pouring, spraying, showering, or otherwise adding the composition, compound, and/or component to the surface. In certain embodiments, addition may be carried out with a shower or spray. In some embodiments, the composition may be heated, such as from about 60° C. to 180° C., prior to addition.

If a solid form of a composition is used, various dispensers known in the art may be used to spray the solid composition (with process water, fluid, or any medium disclosed herein), dissolve a portion thereof to form a working solution, and add the working solution into the process to be used for washing and/or rinsing the surface.

For example, a dispenser may form a solution between a solid (or liquid) product/composition and a medium (e.g., process water) in contact with the solid composition. The dispenser may include an inlet portion configured to introduce the medium into the dispenser system, a solution forming assembly, and an outlet portion configured to dispense liquid solutions.

Additional details regarding dispensers may be found in U.S. Pat. Nos. 10,596,535, 9,850,060, and 9,434,599, the contents of which are expressly incorporated by reference into the present disclosure.

The presently disclosed compositions, compounds, and methods are useful for removing a lubricant, such as an oil, from a surface comprising any material, such as a plastic, a metal, or any combination thereof. In some aspects, the metal surface comprises steel, such as stainless steel or carbon steel. In some aspects, the metal surface comprises iron, aluminum, zinc, chromium, manganese, nickel, tungsten, molybdenum, titanium, vanadium, cobalt, niobium, or copper. The metal surface may also comprise any combination of the foregoing metals and/or any one or more of boron, phosphorus, sulfur, silicon, oxygen, and nitrogen.

In some aspects of the present disclosure, a metal surface may comprise metallic-chrome steel, ferritic-alloy steel, austenitic-steel, precipitation-hardened steel, high-nickel steel, carbon steel, or a combination thereof.

In certain embodiments, the surface comprises steel coated or partially coated with tin.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a rinse aid” is intended to include “at least one rinse aid” or “one or more rinse aids.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

1. A method of removing a contaminant from a surface, comprising:
passing a fluid through a reverse osmosis (RO) membrane to form a RO fluid,
adding a detergent to the RO fluid to form a treated fluid,
applying the treated fluid to the surface,
removing at least a portion of the contaminant from the surface to form a treated surface,
adding a rinse aid to deionized water to form a second treated fluid, and
applying the second treated fluid to the treated surface.

2. The method of claim 1, further comprising washing the surface with a heated fluid prior to application of the treated fluid.

3. The method of claim 1, further comprising heating the RO fluid, the treated fluid, the second treated fluid, or any combination thereof.

4. The method of claim 1, wherein the surface comprises a metal and/or a plastic.

5. The method of claim 1, wherein a can or an automotive component comprises the surface and/or wherein the applying comprises spraying.

6. The method of claim 1, wherein the detergent comprises a member selected from the group consisting of disodium metasilicate, trisodium phosphate, potassium hydroxide, potassium silicate, sodium hydroxide, triphosphono methyl amine, sodium silicate, and any combination thereof.

7. The method of claim 1, wherein the rinse aid comprises a member selected from the group consisting of sodium xylene sulfonate, lactic acid, an ethoxylated alkyl alcohol, and any combination thereof.

8. The method of claim 1, wherein the treated fluid comprises a fluorescent tracer and the method further comprises measuring a fluorescent signal of the treated fluid and adding an additional amount of the rinse aid to the treated fluid if the measured fluorescent signal is below a predetermined level.

9. The method of claim 1, wherein the contaminant is selected from the group consisting of an oil, a lubricant, triethanolamine, 2-butylaminoethanol, tris(2-hydroxyethyl)hexahydro triazine, diethylene glycol, an alkyl ethanolamine, and any combination thereof.

10. The method of claim 1, further comprising adding a second rinse aid to the treated fluid.

11. The method of claim 10, wherein the rinse aid and the second rinse aid are the same and/or wherein the second rinse aid comprises deionized water.

12. A method of removing a lubricant from a surface of a can, comprising:
passing a fluid through a reverse osmosis (RO) membrane to form a RO fluid,
adding a detergent to the RO fluid to form a treated fluid,
spraying the treated fluid onto the surface of the can,
removing at least a portion of the lubricant from the surface to form a treated surface,
adding a rinse aid to deionized water to form a second treated fluid, and
spraying the second treated fluid onto the treated surface.

13. The method of claim 12, further comprising transporting the can to a first position where the treated fluid is sprayed onto the surface of the can.

14. The method of claim 13, further comprising transporting the can to a second position where the second treated fluid is sprayed onto the treated surface.

15. The method of claim 14, wherein the transporting is carried out by a conveyor belt.

16. The method of claim 12, further comprising heating the RO fluid, the treated fluid, the second treated fluid, or any combination thereof.

17. The method of claim 12, wherein the detergent comprises a member selected from the group consisting of disodium metasilicate, trisodium phosphate, potassium hydroxide, potassium silicate, sodium hydroxide, triphosphono methyl amine, sodium silicate, and any combination thereof.

18. The method of claim 12, wherein the rinse aid comprises a member selected from the group consisting of sodium xylene sulfonate, lactic acid, an ethoxylated alkyl alcohol, and any combination thereof.

19. The method of claim 12, wherein the treated fluid comprises a fluorescent tracer and the method further comprises measuring a fluorescent signal of the treated fluid and adding an additional amount of the rinse aid to the treated fluid if the measured fluorescent signal is below a predetermined level.

20. The method of claim 12, further comprising drying the treated surface of the can after spraying the second treated fluid onto the treated surface and before applying a first epoxy coating to the treated surface of the can.
